(19) United States
(12) Patent Application Publication
(10) Pub. No.: US 2012/0210809 A1
(43) Pub. Date: Aug. 23, 2012

(54) Device and Method for Converting Centrifugal Force to Energy

(76) Inventor: Steven Wayne Elliott, SR., Richmond, VA (US)

(21) Appl. No.: 13/032,011

(22) Filed: Feb. 22, 2011

(51) Int. Cl. F16H 33/08

(52) U.S. Cl. 74/64

(57) ABSTRACT

Wherein said machine rotors (2) rotate on their respective axis of rotation (3) generating power as each displace their respective displacement weights (5) by way of their respective displacement mechanisms (4, 12) from the inner bounds of the machine rotor (2) to the outer bounds of the machine rotor. As each displacement mechanism (4, 12) pass and aligns with another, each exchange their displacement weight (5) from the outer bounds of each to the inner bounds of the other resetting the displacement weights (5) to the inner bounds of each opposing and aligned displacement mechanism (4, 12) allowing displacement to repeat with the next synchronized rotation of the machine rotors (2). Each overlapping pair of displacement mechanisms (4, 12) will continue to displace and reset with each new rotation of the two parallel, overlapping, and synchronized machine rotors (2).

The present invention and its multiple embodiments can be coupled in a variety of orientations including, but not limited to horizontal or vertical to one or more electrical generator(s) (11) or other work applications by a drive shaft (10) or other means.

The methods referenced here for transferring energy generated by this device to a generator or other work applications include but are not limited to the possibilities presented above.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a device, and method, for converting centrifugal force to usable energy whereby centrifugal force can be harnessed for beneficial purposed with high efficiency.

Energy generation is vital to the survival and advancement of civilization. There is a continual desire to harness energy from non-depletable resources such as wind, tidal fluctuations and gravitational force. This desire will continue until the use of depletable resources, such as fossil fuels, is substantially reduced.

Harnessing energy from tidal fluctuations has been explored for many years. This method is limited by proximity to and ocean and by the corrosive nature of seawater. It is apparent to those of skill in the art that reducing mechanical losses, such as friction, is critical to efficient energy conversion. The corrosive nature of seawater is contrary to this desire.

Wind energy is widely used. This methods limited by the variability of wind. The unpredictable nature of wind requires that any wind based energy generation system have a supplemental energy source. In high wind conditions a wind based energy generation system must be able to capture the wind efficiently, typically by rotation a less than efficient device. Failure to capture the maximum amount of power is often referred to in the art as spilling. This non-energy producing rotation causes the various components to wear unnecessarily.

Harnessing energy from centrifugal force would be of great advantage. The rotational velocity of a device is the method by which centrifugal force is generated. The force required to accelerate the rotational velocity of the device is greater than that required to maintain a constant rotational velocity once achieved. An outside force will be required to accelerate the device to the required rotational velocity. The energy produced by this device at its optimal rotational velocity is expected to exceed the energy required to maintain its optimal rotational velocity. This method of energy generation will allow energy generation systems to be virtually universal without regard for terrain, weather, or other uncontrollable events such as those related to geography and political systems. Harnessing centrifugal force in the manner herein described would greatly benefit humankind.

A system described by Elliott in U.S. Pat. Publ. No. 2004/0247459 has shown great promise as a system for transferring gravitation to energy. This advance has led to the realization that further improvements in the efficiencies would provide even greater opportunity for widespread use as an alternate energy source. It's from this system the Device and Method for Converting Centrifugal Force to Energy is derived. This system when coupled to the Device and Method for Converting Centrifugal Force to Energy could be used to generate the accelerating rotational velocity required. In ether event, the Device and Method for Converting Centrifugal Force to Energy would be greatly beneficial to humankind.

It has been an ongoing desire to harness gravitational forces as a means of generating energy. I suspect there to be indifference as to whether such force is natural or simulated. In some futuristic space station designs by NASA and others, a wheel like space station is set in rotational motion about an axis to create enough centrifugal force against the inside wall of the space station outer casing to simulate earth's gravity. The goal of harnessing this force to accomplish another task of produce energy can be achieved with the present invention.

### BRIEF SUMMARY OF THE INVENTION

It is an object of the present invention to provide a method of harnessing energy from centrifugal force.

It is another object of the present invention to harness energy efficiently and without the necessity for auxiliary power once a required rotational velocity has been achieved.

A particular feature of the present invention is the simplicity of the inventive device and the minimal number of moving parts required to achieve the stated objects.

Another particular feature is the ability to utilize the present invention in any location without regard to geography or environmental concerns.

Another feature of the present invention is the improvement in overall efficiency of the system with regards to the amount of energy generated by rotation and displacement.

Wherein said two parallel, overlapping, and synchronized machine rotors rotate on their respective axis of rotation generating power as each displace their respective displacement weights by way of their respective displacement mechanisms from the inner bounds of the machine rotor to the outer bounds of the machine rotor. As each displacement mechanism rotates and align with another, each exchange their displacement weight from the outer bounds of each to the inner bounds of the other resetting the displacement weights to the inner bounds of each opposing and aligned displacement mechanism allowing displacement to repeat with the next synchronized rotation of the machine rotors. Each overlapping pair of displacement mechanisms will continue to displace, generate power with each displacement, and reset with each new rotation of the two parallel, synchronized and overlapping machine rotors.

Note: Wherever the term parallel is used in reference to the machine rotor it is understood to mean parallel planes.

### BRIEF DESCRIPTION OF THE SEVERAL VIEWS OF THE DRAWING

FIG. 1 is a top down view of an embodiment of the present invention, constituting a device for converting centrifugal force to energy, prior to rotational acceleration and the response to centrifugal force.

FIG. 2 is a top down break out view of one machine rotor set in relief from the embodiment of FIG. 1

FIG. 3 is a schematic representation of a single displacement slide track with the displacement weight located at its inner most position relative to the machine rotor axis of rotation.

FIG. 4 is a schematic representation of an approximate 90 degrees rotation of the displacement slide track about the machine rotor axis of rotation and the displacement weight's distance and path of displacement from that represented in FIG. 3.

FIG. 5 is a schematic representation of an approximate 180 degrees rotation of the displacement slide track about the machine rotor axis of rotation and displacement weight's distance and path of displacement from that represented in FIG. 3.

FIG. 6 is a schematic representation of an approximate 270 degrees rotation of the displacement slide track about the machine rotor axis of rotation and displacement weight's distance and path of displacement from that represented in FIG. 3.

FIG. 7 is a schematic representation of an approximate 360 degrees rotation of the displacement slide track about the machine rotor axis of rotation and displacement weight's distance and path of displacement from that represented in FIG. 3.

FIG. 8 is a top down look at the embodiment with each of two machine rotors overlapping, synchronized and rotating in opposite directions and the path taken by each displacement weight on each of two opposing displacement slide tracks.

FIG. 9 is a top down view of an embodiment of the present invention prior to an exchange of displacement weights from the outer most position of a displacement slide track of each of the two machine rotors to an opposing inside most position of the other.

FIG. 10 is a top down view of an embodiment of the present invention showing the exchange of displacement weights from the outer most position of a displacement slide track of each of the two machine rotors to an opposing inside most position of the other.

FIG. 11 is a top down view of an embodiment of the present invention after an exchange of displacement weights from the outer most position of a displacement slide track of each of the two machine rotors to an opposing inside most position of the other.

FIG. 12 is a side view schematic representation of an embodiment of the present invention showing two machine rotors parallel, overlapping and synchronized.

FIG. 13 is a side view schematic representation of an embodiment of the present invention wherein multiple devices are coupled vertically to a generator.

FIG. 14 is a top down view of another embodiment of the present invention prior to rotational acceleration and the response to centrifugal force.

FIG. 15 is a top down break out view of one machine rotor set in relief from the embodiment of FIG. 14.

FIG. 16 is a schematic representation of a single displacement rotor with the displacement weight located at its inner most position relative to the machine rotor axis of rotation.

FIG. 17 is a schematic representation of an approximate 90 degrees rotation of the displacement rotor about the machine rotor axis of rotation and the displacement weight's distance and path of displacement from that represented in FIG. 16.

FIG. 18 is a schematic representation of an approximate 180 degrees rotation of the displacement rotor about the machine rotor axis of rotation and displacement weight's distance and path of displacement from that represented in FIG. 16.

FIG. 19 is a schematic representation of an approximate 270 degrees rotation of the displacement rotor about the machine rotor axis of rotation and displacement weight's distance and path of displacement from that represented in FIG. 16.

FIG. 20 is a schematic representation of an approximate 360 degrees rotation of the displacement rotor about the machine rotor axis of rotation and displacement weight's distance and path of displacement from that represented in FIG. 16.

FIG. 21 is a top down look at the embodiment with each of two machine rotors parallel, overlapping, synchronized and rotating in the same direction and the path taken by each displacement weights on each of two opposing machine and displacement rotors.

FIG. 22 is a top down view of an embodiment of the present invention prior to and approaching an exchange of displacement weights from the outer most position of a displacement rotor on each of the two machine rotors to an opposing inside most position of other.

FIG. 23 is a top down view of an embodiment of the present invention showing the exchange of displacement weights from the outer most position of a displacement rotor on each of the two machine rotors to an opposing inside most position of the other.

FIG. 24 is a top down view of an embodiment of the present invention after an exchange of displacement weights from the outer most position of a displacement rotor on each of the two machine rotors to an opposing inside most position of the other.

FIG. 25 is a side view schematic representation of an embodiment of the present invention showing two machine rotors parallel, overlapping and synchronized.

FIG. 26 is a side view schematic representation of an embodiment of the present invention wherein multiple devices are coupled vertically to a generator showing two machine rotors parallel, overlapping and synchronized. The embodiments and their arrangements are not limited to the prior schematics. There are many ways in which multiple devices can be connected and arranged.

### DETAILED DESCRIPTION OF THE INVENTION

The inventor of the present application has developed, through diligent research, a device capable of efficiently harnessing energy from centrifugal force. The inventor has also developed a method for incorporating such an inventive device in a system for generating energy from centrifugal force.

The invention will be described with reference to the figures forming a part of the present application. In the various figures similar elements are numbered accordingly. For the purpose of clarity centrifugal force (7) is directed away from the machine axis of rotation and perpendicular to its drive shaft.

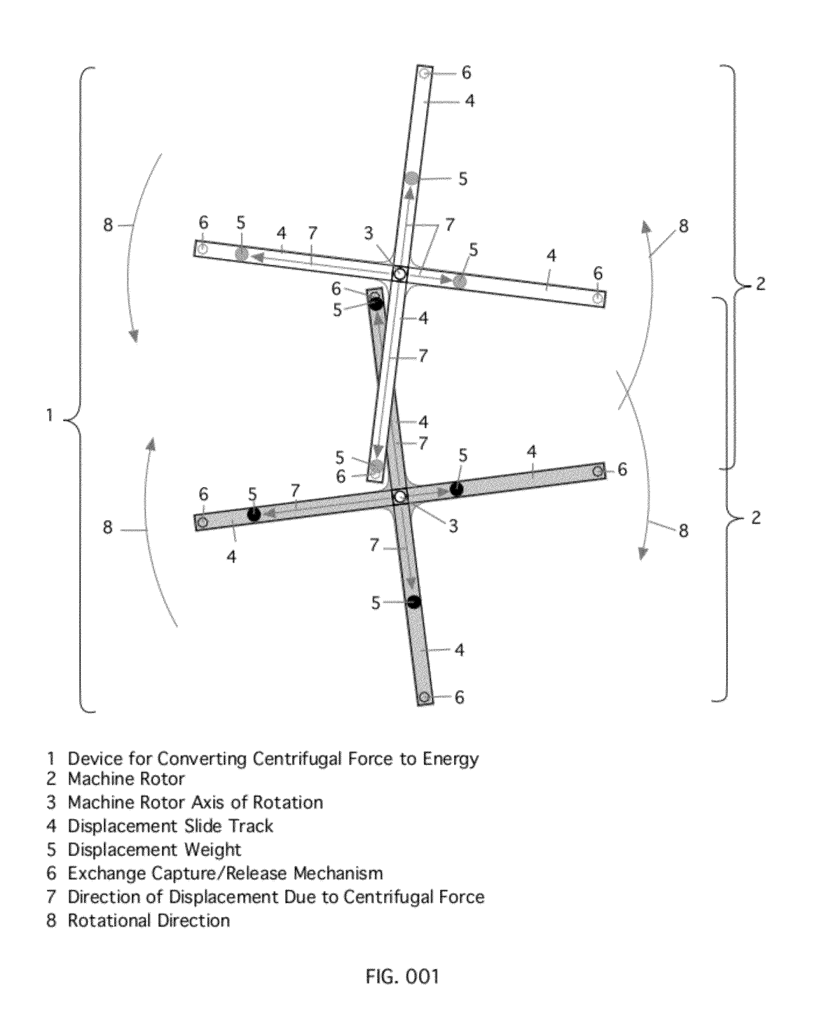

The embodiment of the present invention is provided and will be described with references to FIGS. 1 through 13. For purposes of clarity the machine rotors will rotate in opposite directions in the direction indicated by rotational direction arrows (8).

FIG. 1 is a top down view of an embodiment of the present invention prior to rotational acceleration and response to centrifugal force.

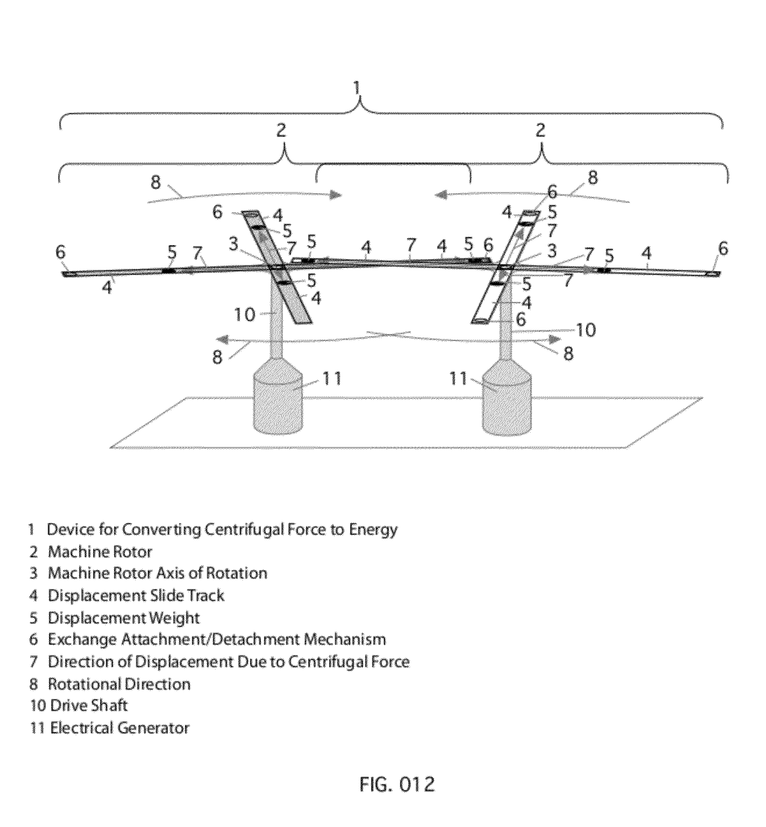

An embodiment of the present invention, generally represented as (1), in FIG. 1, consists of two or more machine rotors, (2), each with an axis of rotation (3) each rotating in opposite directions on parallel planes, overlapping and synchronized each with the other as seen in FIG. 12. The machine rotors, (2) each have an inner portion closest to, and in this embodiment the same as, the machine rotor axis of rotation (3) and an outer portion defined by the location and dimensions of the displacement slide tracks (4).

The displacement slide tracks (4) attached to the outer portion of each machine rotor (2) aligned such that one end is closest to the machine rotor axis of rotation (3) and the other end is farthest away from the machine rotor axis of rotation.
A displacement weight (5) is attachable and detachable to, and is displaces along, the displacement slide track (4) in response to centrifugal force (7).
An exchange capture/release mechanism (6) is located at each end of the displacement slide track (4) to capture the displacement weight (5) at the end closest to the machine rotor axis of rotation allowing the displacement weight, 5, in response to centrifugal force (7) to move outward to the end farthest away from the machine rotor axis of rotation (3) and released to an opposing and aligned displacement slide track attached to an adjacent machine rotor (2).

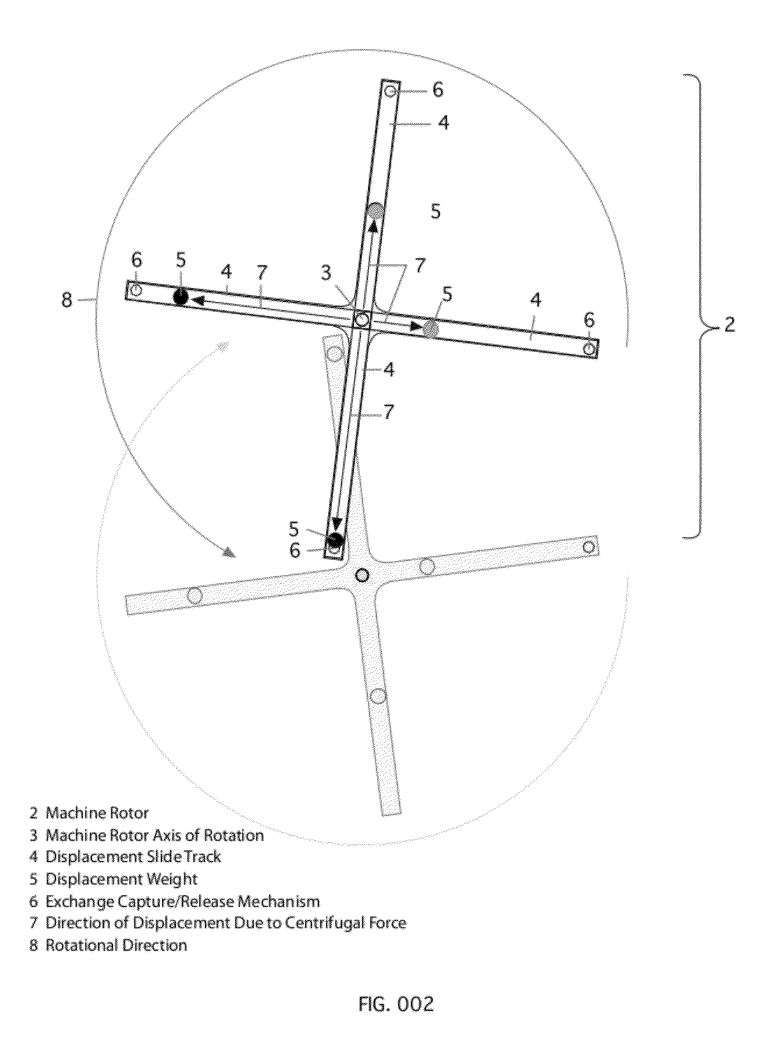

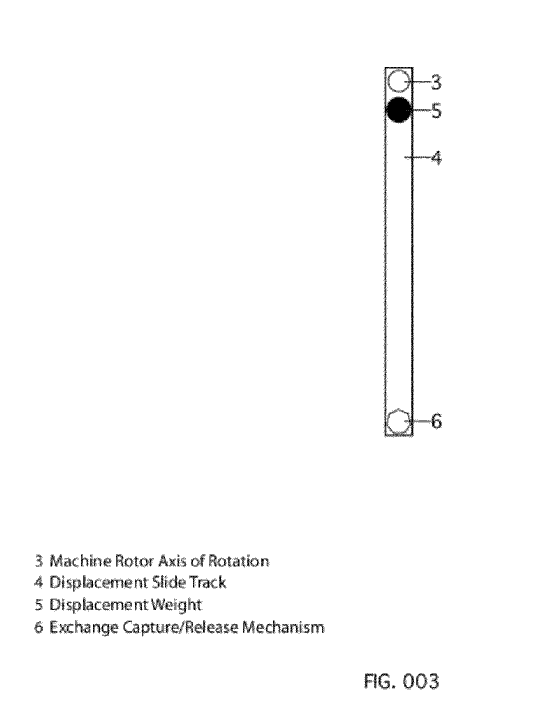

FIG. 2 is a top down break out view of one machine rotor (2) set in relief from the embodiment of FIG. 1 to show more clearly that it contains four individual displacement slide tracks (4) and to put in context the discussion of FIGS. 3 through 7.

In FIG. 3, a single displacement slide track (4) with the displacement weight (5) located at its inner most position relative to the machine rotor axis of rotation (3).

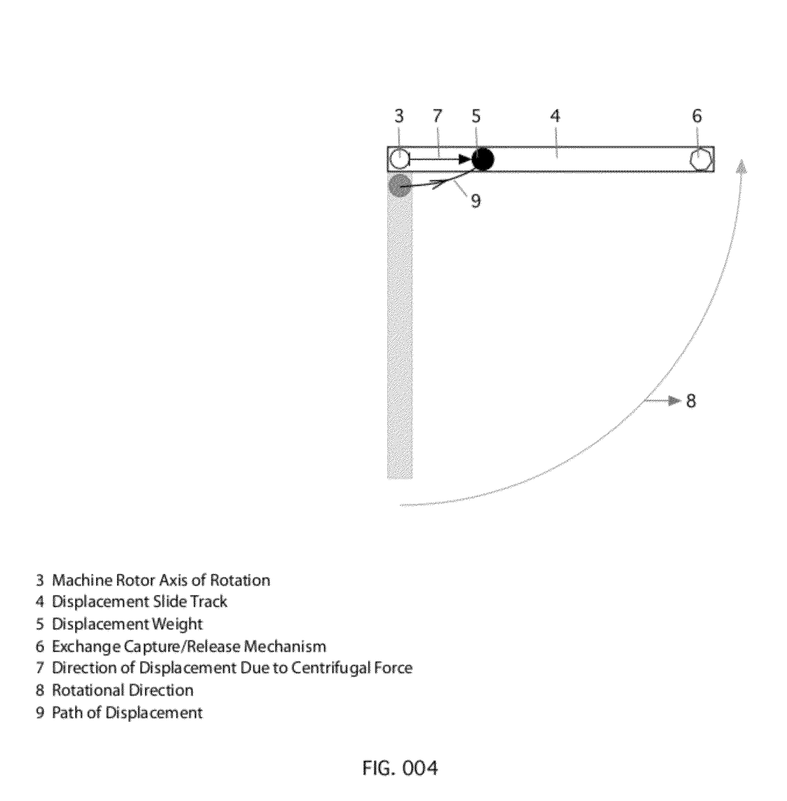

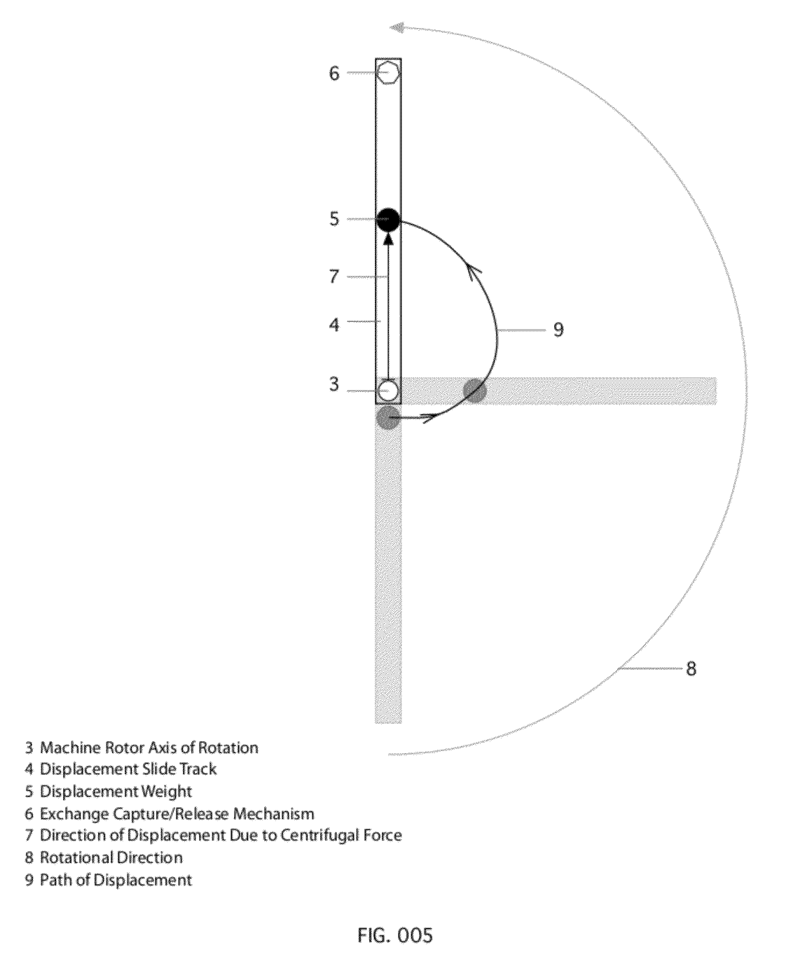

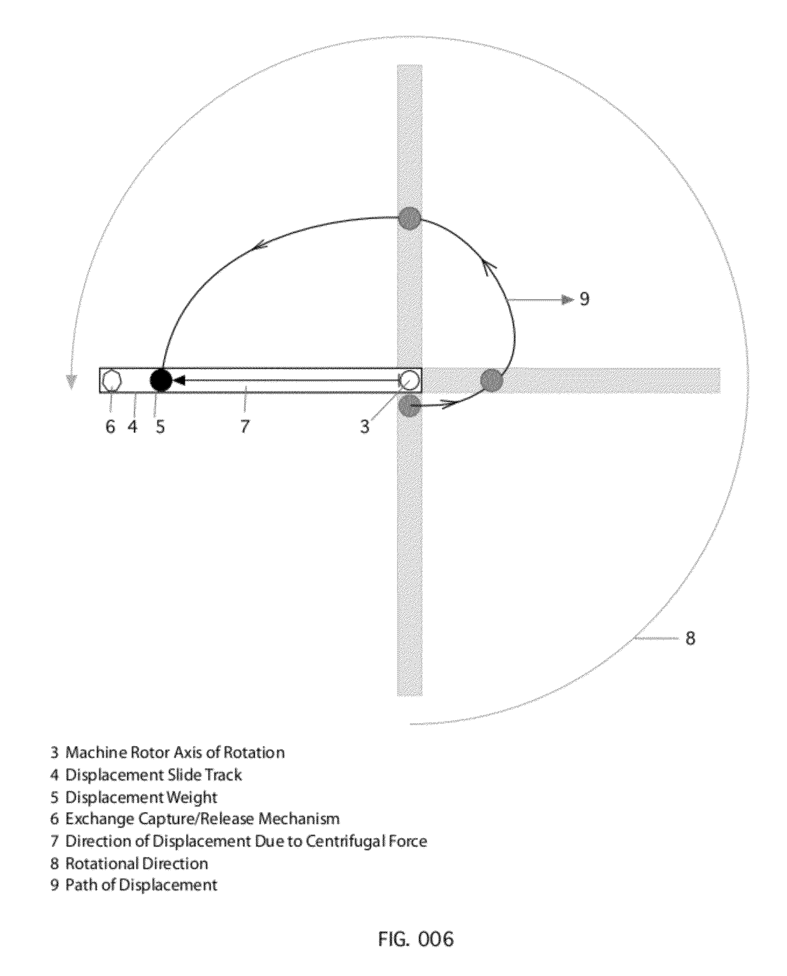

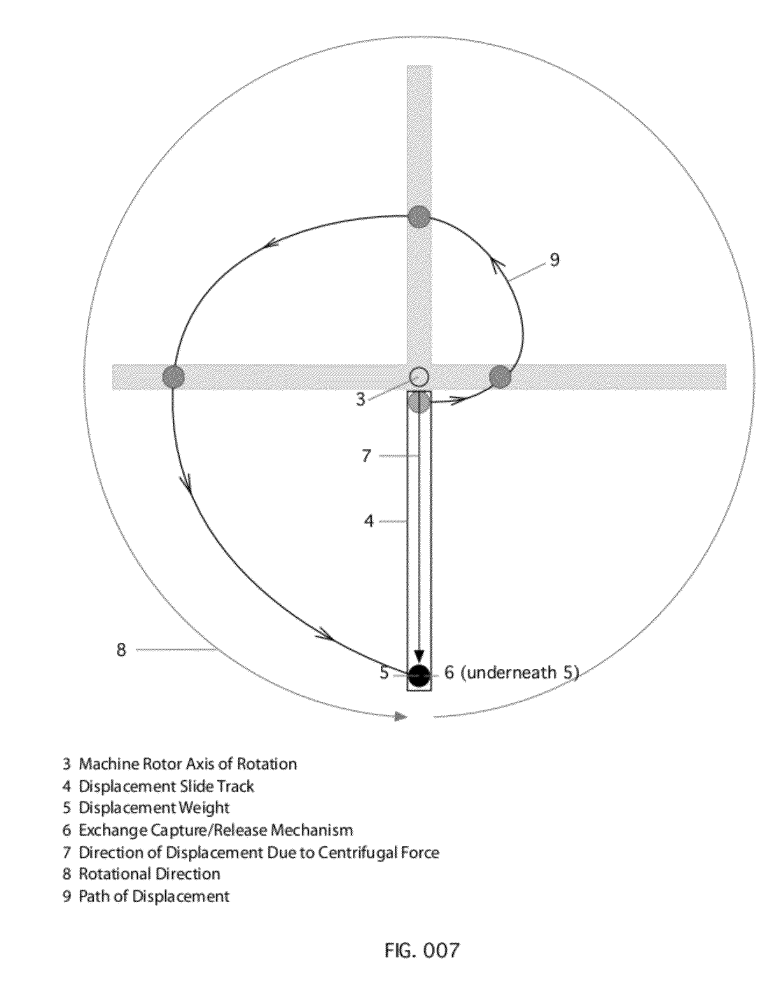

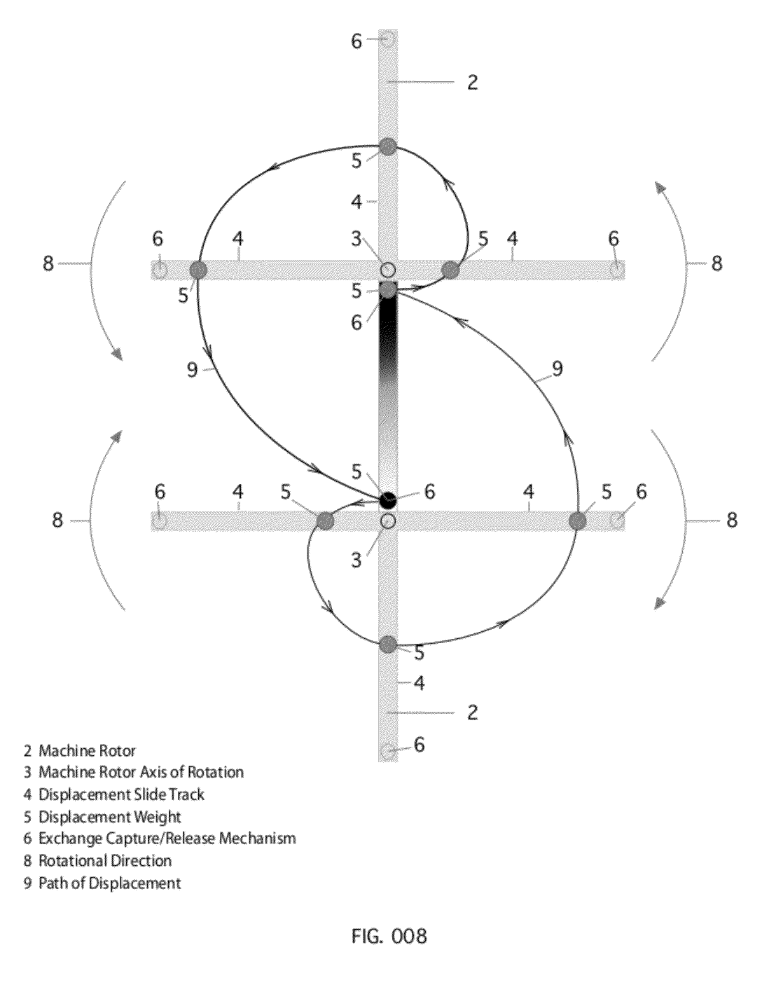

FIG. 4 illustrates a single displacement slide track (4) at an approximate 90 degrees rotation of the displacement slide track and the displacement weight's distance and path of displacement from that represented in FIG. 3; FIG. 5 illustrates a single displacement slide track (4) at an approximate 180 degrees rotation of the displacement slide track and displacement weight's distance and path of displacement from that represented in FIG. 3; FIG. 6 illustrates a single displacement slide track (4) at an approximate 270 degrees rotation of the displacement slide track and displacement weight's distance and path of displacement from that represented in FIG. 3; FIG. 7 illustrates a single displacement slide track (4) at an approximate 360 degrees rotation of the displacement slide track and displacement weight's distance and path of displacement (9) from that represented in FIG. 3.
FIG. 8 summarizes FIGS. 3 through 7. It is a top down look at the embodiment with each of two machine rotors (2) operating on parallel planes, overlapping, and synchronized with the path of displacement (9) taken by each displacement weight (5) on each of two opposing displacement slide tracks (4) positioned for exchange to the inner end of an opposing displacement slide tracks. Each displacement weight (5) is now reset to rotate and displace again.

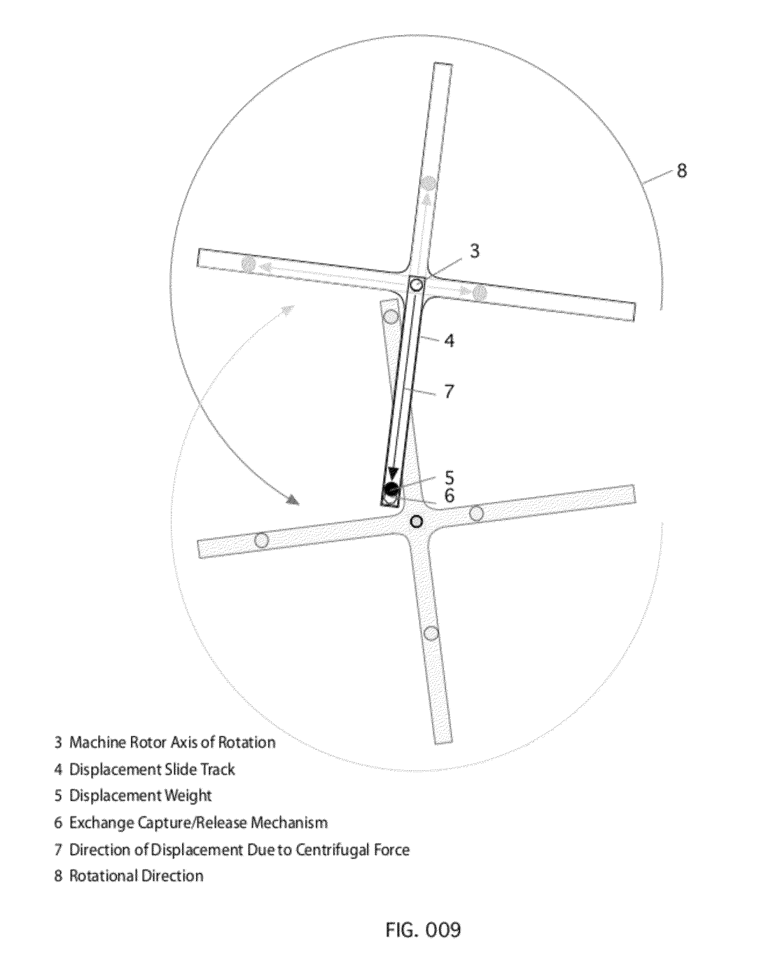

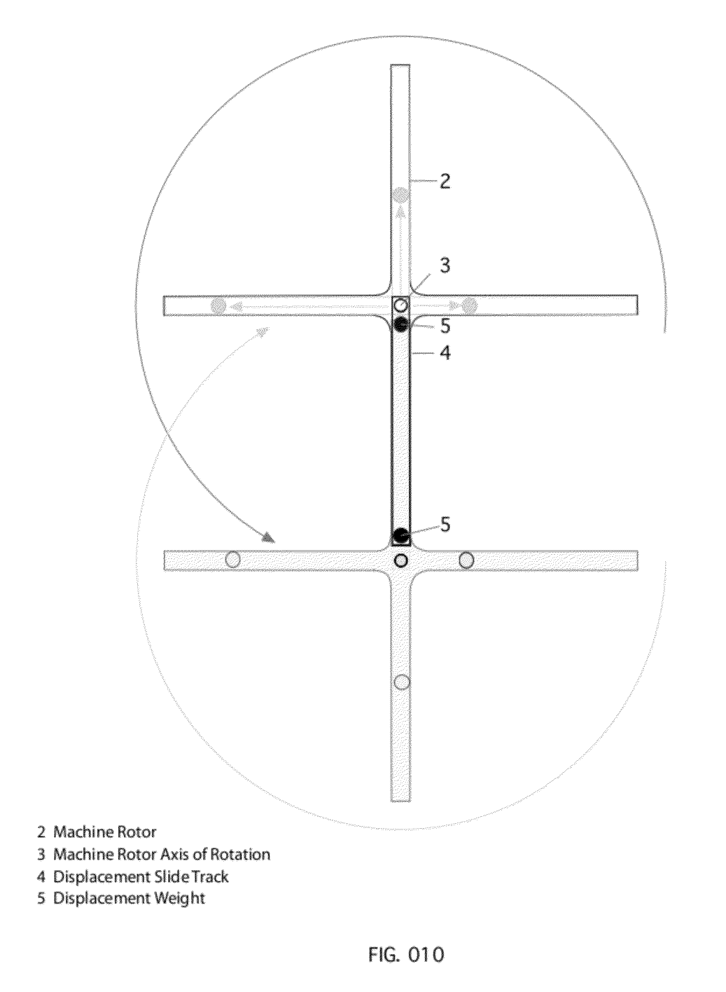

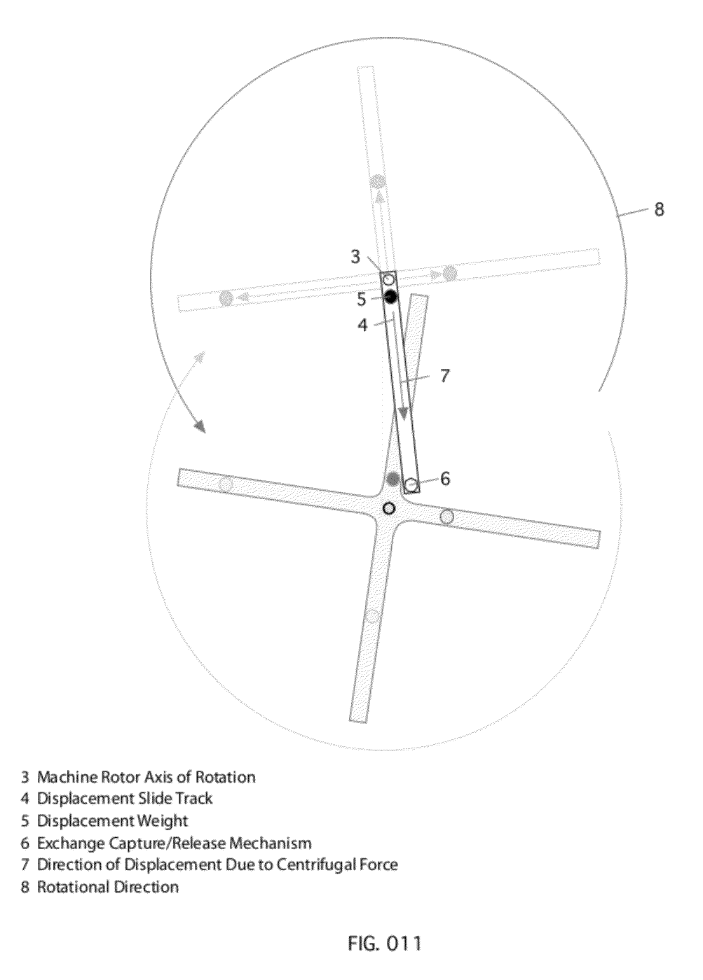

FIGS. 9 through 11 illustrates the before, during and after exchange of two displacement weights (5). FIG. 9 is a top down view of an embodiment of the present invention prior to an exchange of displacement weights (5) from the outer most position of the displacement slide track (4) of each of the two machine rotors (2) to the opposing inside most position of the other. FIG. 10 is a top down view of an embodiment of the present invention showing the exchange of displacement weights (5) from the outer most position of the displacement slide track (4) of each of the two machine rotors (2) to the opposing inside most position of the other. FIG. 11 is a top down view of an embodiment of the present invention after an exchange of displacement weights (5) from the outer most position of the displacement slide track (4) of each of the two machine rotors (2) to the opposing inside most position of the other.

FIG. 12 is a side view schematic representation of the embodiment the invention described above consisting of two machine rotors (2) each with an axis of rotation (3) each rotating on parallel planes, overlapping and synchronized each with the other.

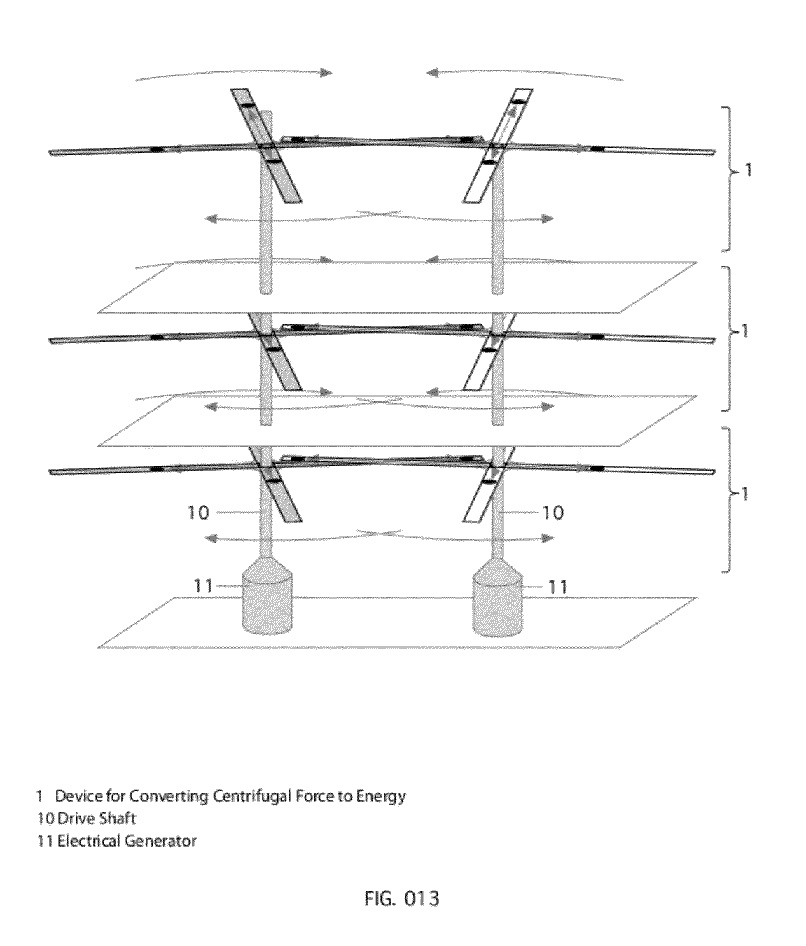

FIG. 13 is a side view schematic representation of an embodiment of the present invention wherein multiple devices (1) are coupled vertically to an electrical generator (11) by a drive shaft (10).

In summary, wherein said machine rotors (2) rotate on their respective axes of rotation (3) generating power as each displace their respective displacement weights (5) by way of the displacement slide track (4) from the inner bounds of the machine rotor (2) to the outer bounds of the machine rotor. As each displacement slide track (4) pass and aligns with another, each exchange their displacement weight (5) from the outer bounds of each to the inner bounds of the other resetting the displacement weights (5) to the inner bounds of each opposing and aligned displacement slide track (4) allowing displacement to repeat with the next synchronized rotation of the machine rotors (2). Each overlapping pair of displacement slide tracks (4) will continue to displace and reset with each new rotation of the two parallel, synchronized and overlapping machine rotors (2).

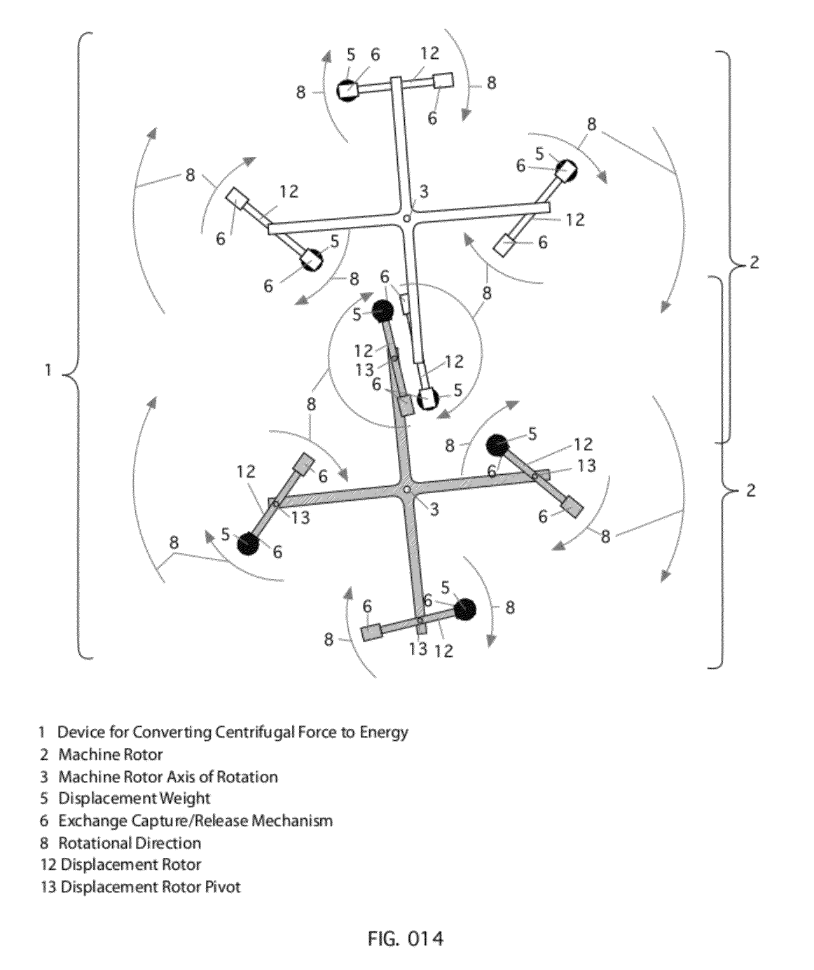

Another embodiment of the present invention is provided and will be described with references to FIGS. 14 through 26. For purposes of clarity the machine rotors (2) and displacement rotors (12) will all rotate in the same clockwise direction as indicated by rotational direction (8) arrows.

FIG. 14 is a top down view of an embodiment of the present invention prior to acceleration and response to centrifugal force.

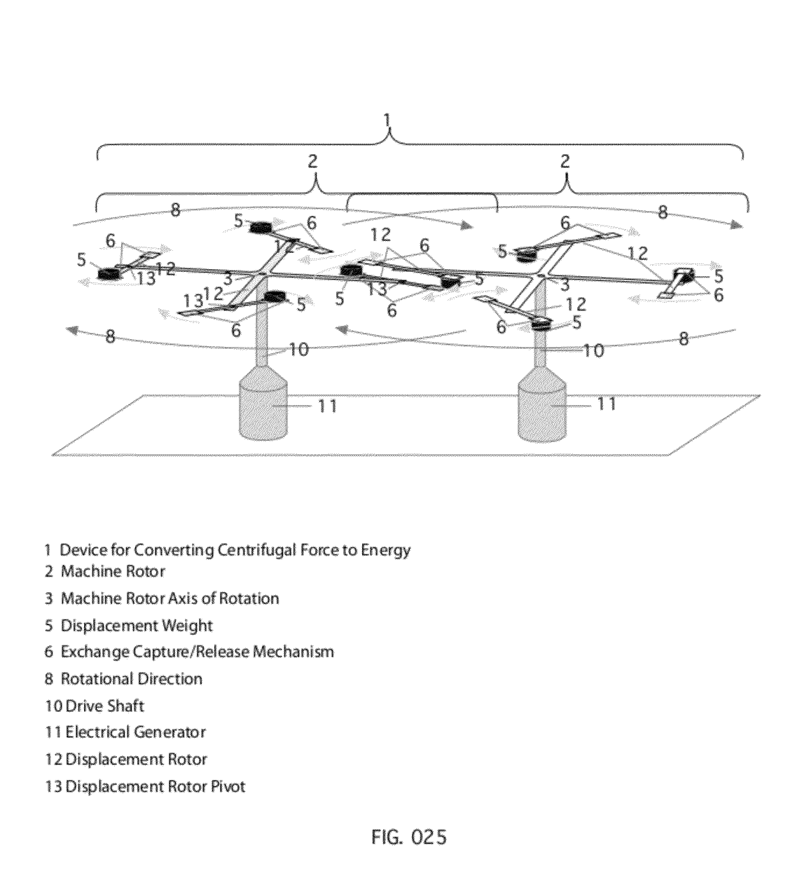

Another embodiment of the present invention, generally represented as (1) in FIG. 14, consists of two or more machine rotors (2) each with an axis of rotation (3) each rotating on parallel planes, overlapping and synchronized each with the other as seen in FIG. 25. The machine rotors (2) each have an inner portion closest to the machine rotor axis of rotation (3) and an outer portion containing and defined by the location and operational dimensions of the displacement rotor (12).

A set of displacement rotors (12) attached to the outer portion of each machine rotor (2) having a displacement rotor pivot (13) that bi-sects a lever to which one end a weight is attached thereto causing an offset center of balance thereby allowing the displacement rotor (12) to rotate on its pivot (13) such that the segment of the lever closest to the machine rotational axis with attached displacement weight (5) rotates to the outer position farthest from machine rotational axis.
A displacement weight (5) is captured by way of the exchange capture/release mechanism (6) to the inner most end of the displacement rotor (12) and displaces rotationally about the displacement rotor pivot (13) in response to centrifugal force, (7).
An exchange capture/release mechanism (6) is located at each end of the displacement rotor (4) to capture the displacement weight (5) at the end of the lever closest to the machine rotor axis of rotation (3) allowing the displacement weight (5) in response to centrifugal force (7) to rotate about the displacement rotor pivot (13) to the point farthest from the machine rotor axis of rotation (3) and released to an opposing and aligned displacement rotor (12) attached to an adjacent parallel, overlapping and synchronized machine rotor (2).

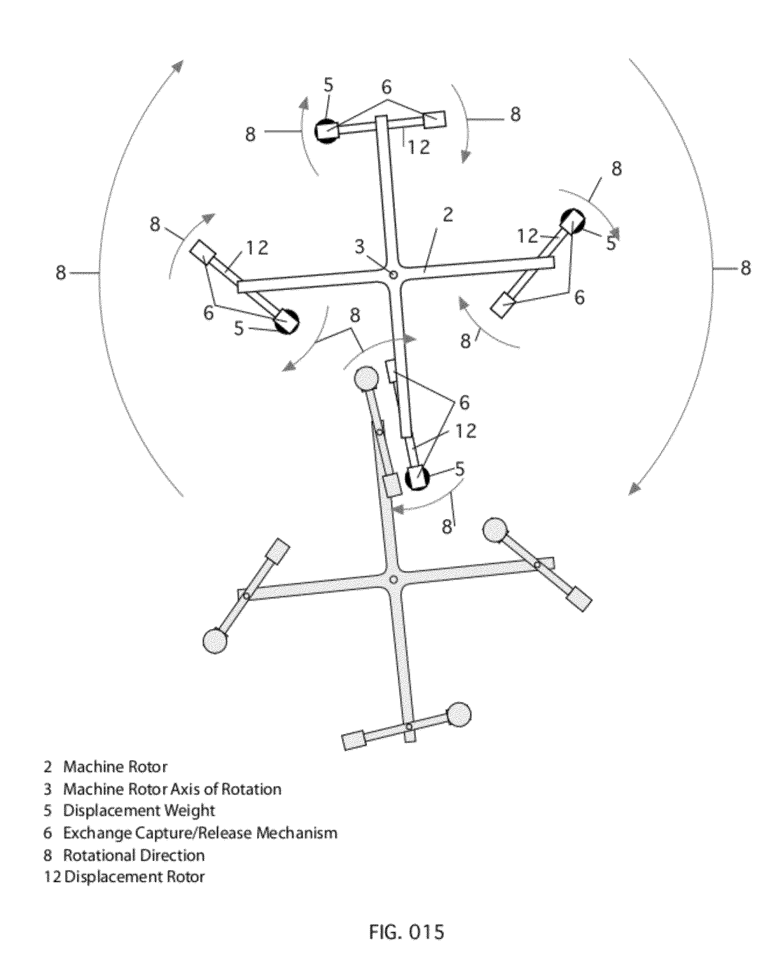

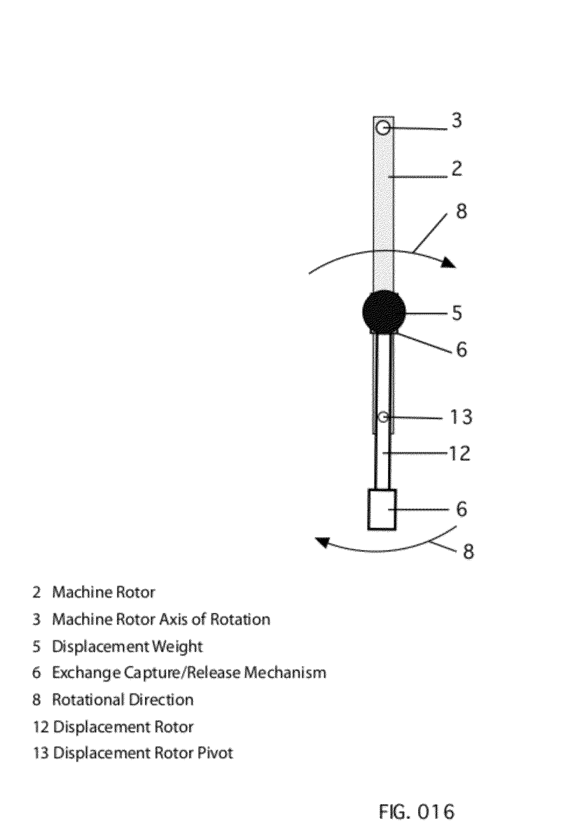

FIG. 15 is a top down break out view of one machine rotor (2) set in relief from the embodiment of FIG. 14 to show more clearly that it contains four individual displacement rotors (12) and to put in context the discussion of FIGS. 16 through 20.

In FIG. 16, a single displacement rotor (12) with the displacement weight (5) located at its inner most position relative to the machine rotor axis of rotation (3).

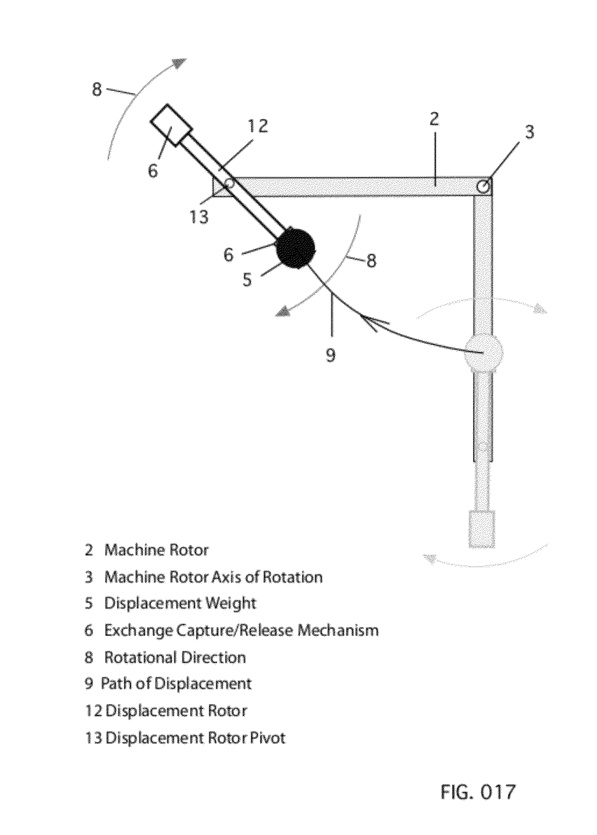

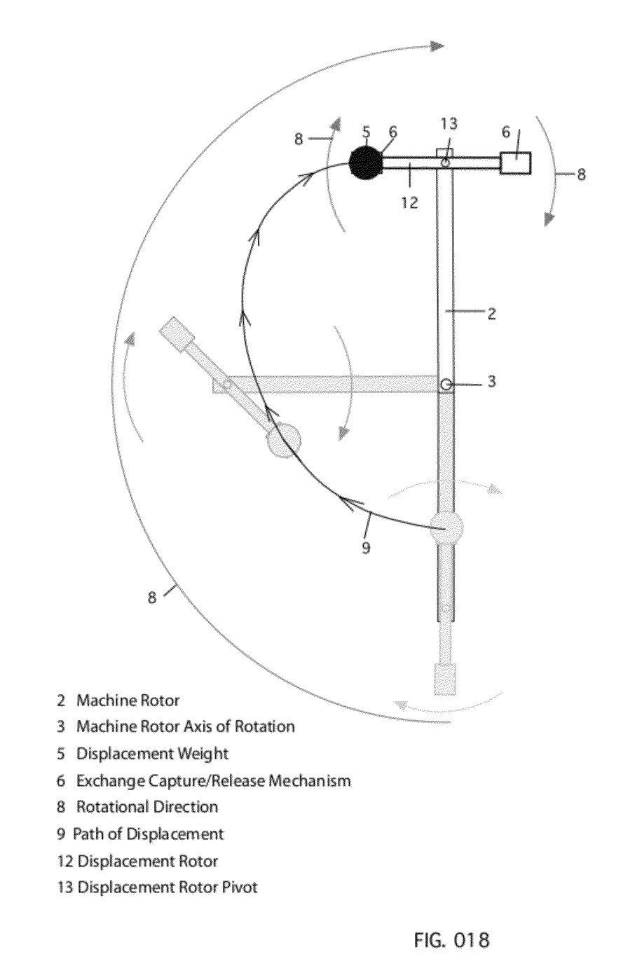

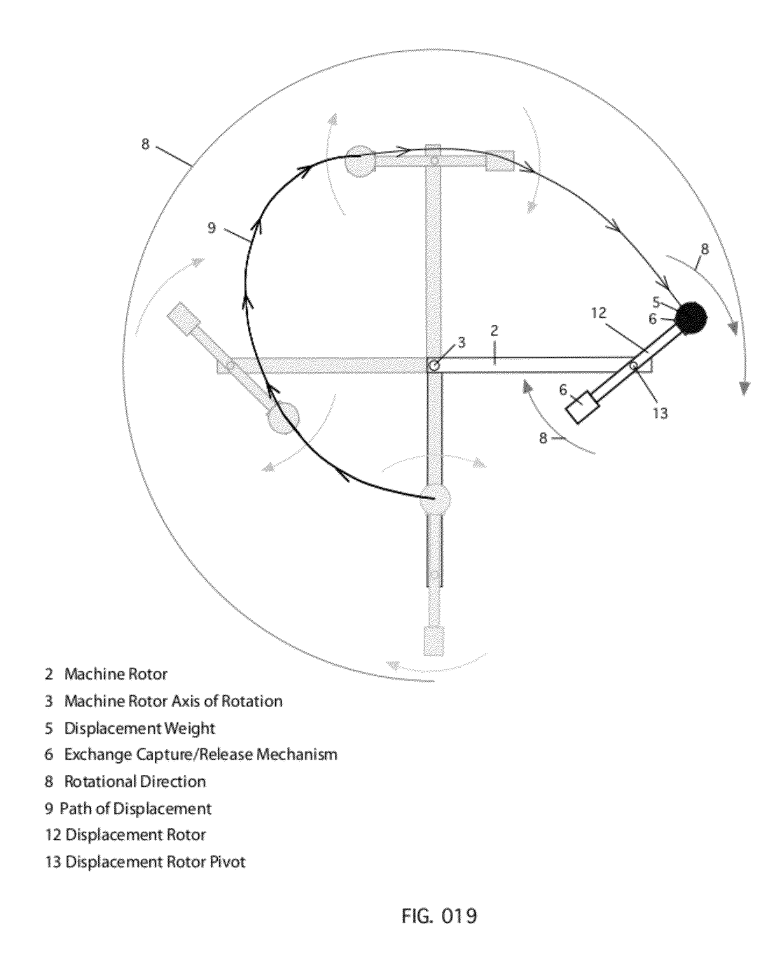

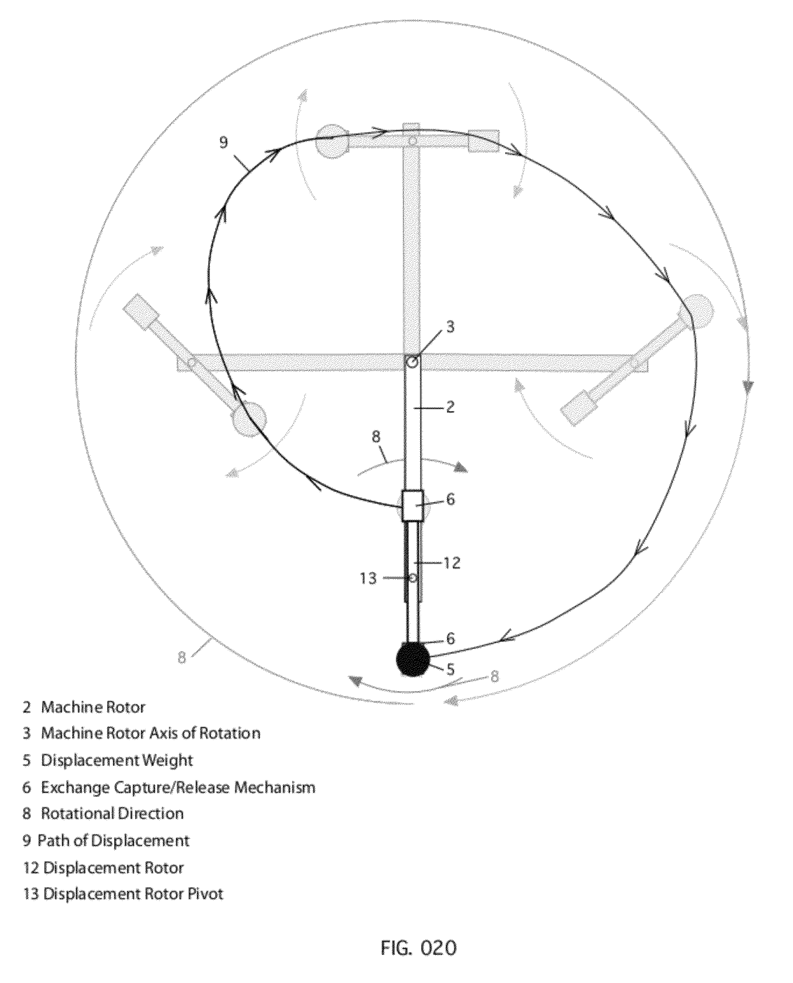

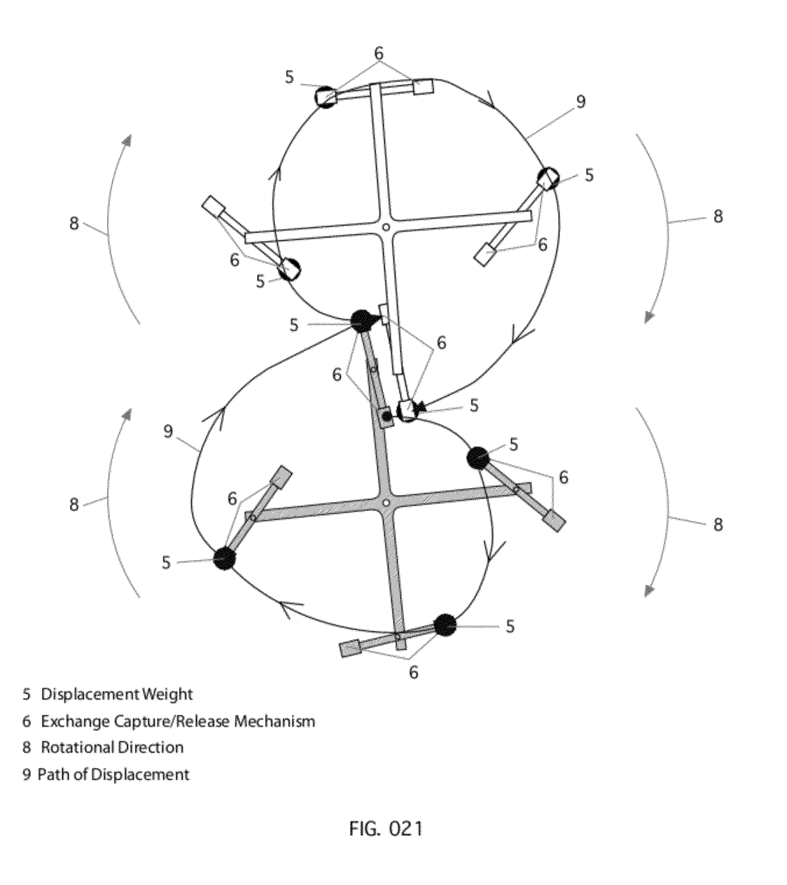

FIG. 17 illustrates a single displacement rotor (12) at an approximate 90 degrees rotation of the displacement rotor and the displacement weight's distance and path of displacement (9) from that represented in FIG. 16; FIG. 18 illustrates a single displacement rotor (12) at an approximate 180 degrees rotation of the displacement rotor (12) and displacement weight's distance and path of displacement (9) from that represented in FIG. 16; FIG. 19 illustrates a single displacement rotor (12) at an approximate 270 degrees rotation of the displacement rotor (12) and displacement weight's distance and path of displacement (9) from that represented in FIG. 16; FIG. 20 illustrates a single displacement rotor (12) at an approximate 360 degrees rotation of the displacement rotor and displacement weight's distance and path of displacement from that represented in FIG. 16.
FIG. 21 summarizes FIGS. 16 through 20. It is a top down look at the embodiment with each of two machine rotors (2) operating on parallel planes, overlapping, and synchronized with the path of displacement (9) taken by each of two displacement weights (5) on each of two opposing displacement rotors (12) positioned for exchange to the inner end of the opposing displacement rotor (12). Each displacement weight (5) is now reset to rotate and displace again.

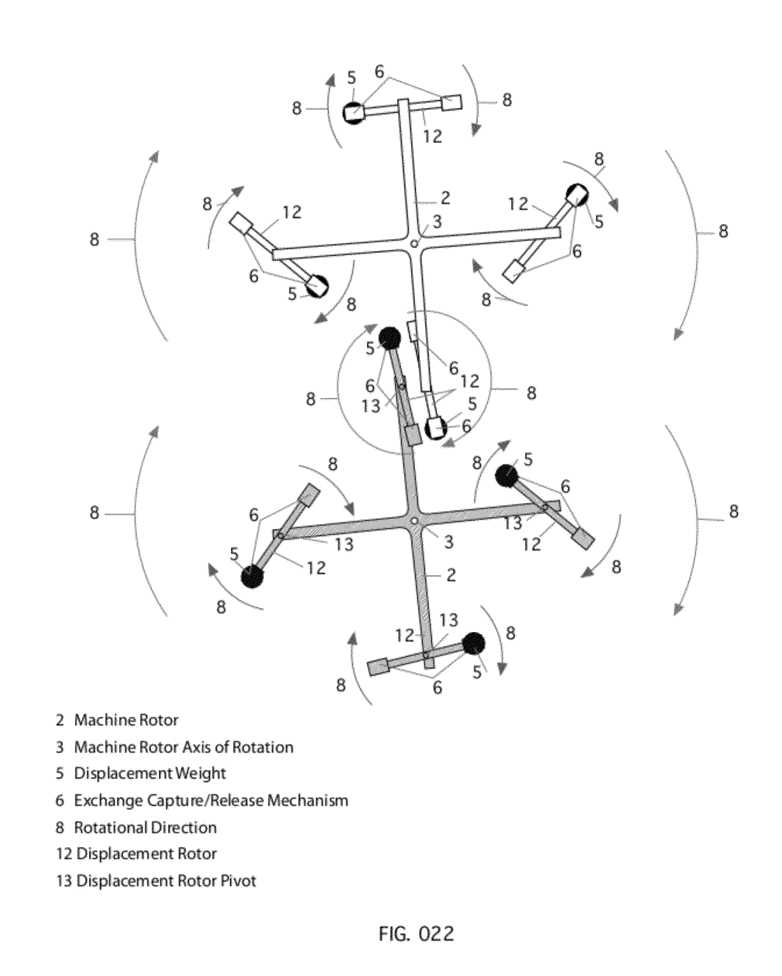

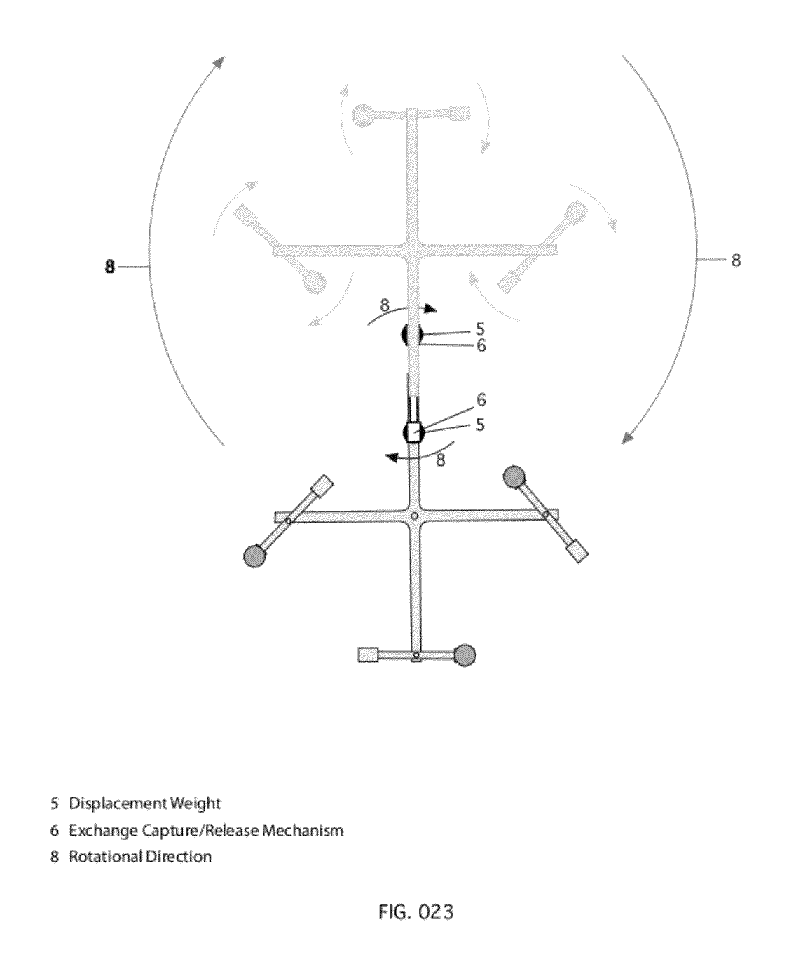

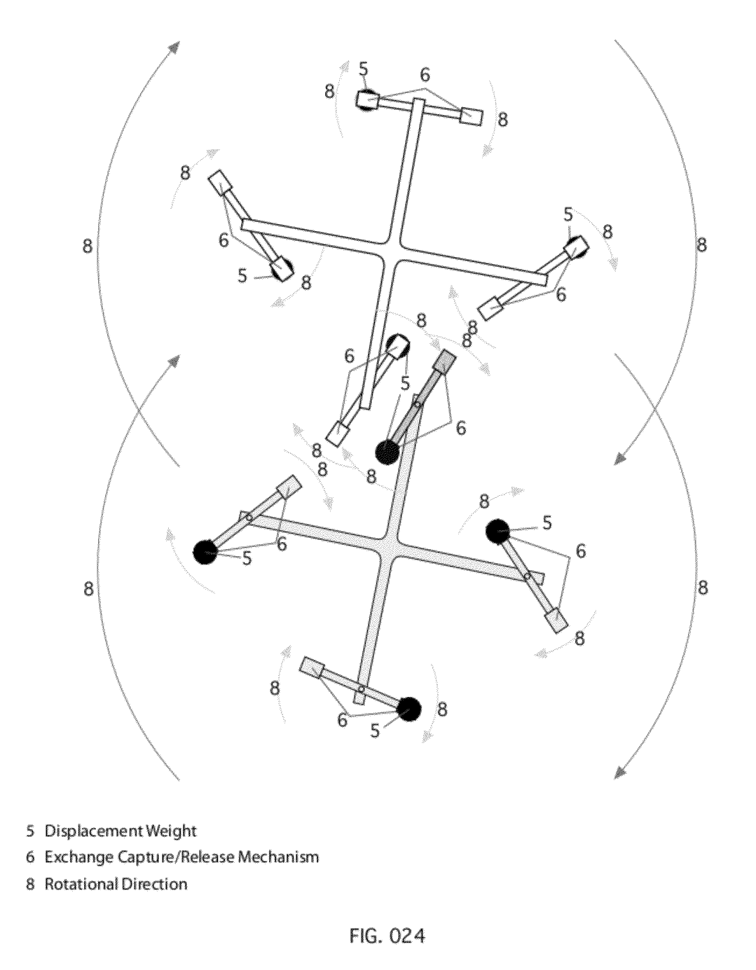

FIGS. 22 through 24 illustrates the before, during and after exchange of two displacement weights (5). FIG. 22 is a top down view of an embodiment of the present invention prior to an exchange of displacement weights from the outer most position of the displacement rotor (12) of each of the two machine rotors (2) to the opposing inside most position of the other. FIG. 23 is a top down view of an embodiment of the present invention showing the exchange of displacement weights (5) from the outer most position of the displacement rotor (12) of each of the two machine rotors (2) to the opposing inside most position of the other. FIG. 24 is a top down view of an embodiment of the present invention after an exchange of displacement weights (5) from the outer most position of the displacement rotor (12) of each of the two machine rotors (2) to the opposing inside most position of the other.

FIG. 25 is a side view schematic representation of the embodiment the invention described above consisting of two machine rotors (2) each with an axis of rotation (3) each rotating on parallel planes, overlapping and synchronized each with the other.

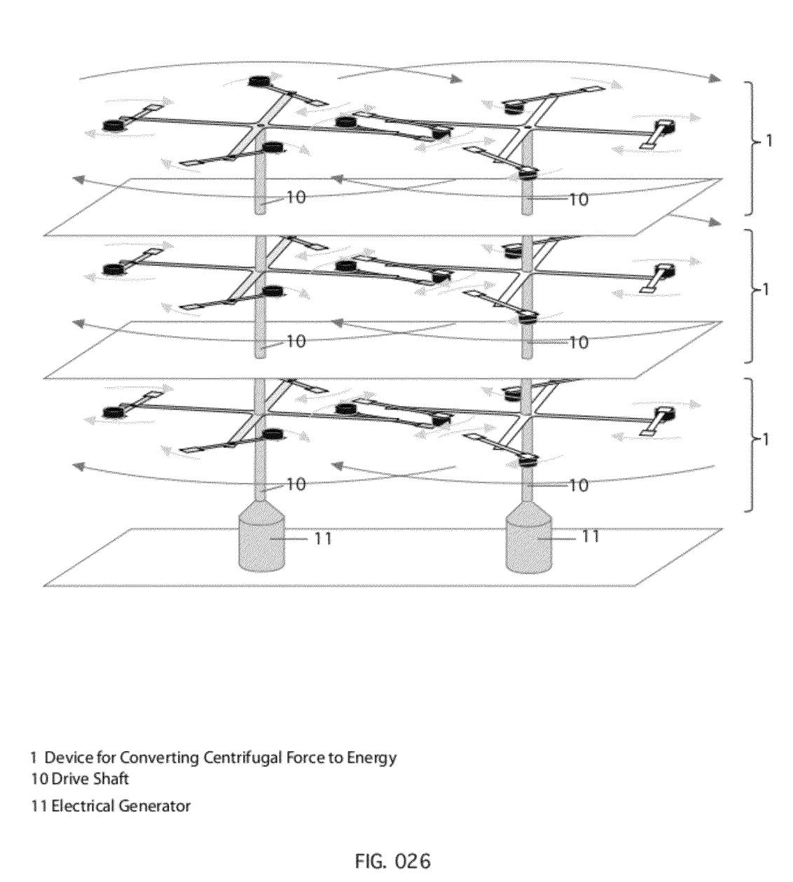

FIG. 26 is a side view schematic representation of an embodiment of the present invention wherein multiple devices are coupled vertically to two electrical generators (11) by a drive shaft (10).

FIG. 27 is a side view schematic representation of and embodiment of the present invention wherein multiple devices are coupled horizontally to a single electrical generator (11) by a drive shaft (10).

To summarize, wherein said machine rotors (2) rotate on their respective axis of rotation (3) generating power as each displace their respective displacement weights (5) by way of the displacement rotors (12) from the inner bounds of the machine rotor (2) to the outer bounds of the machine rotor. As each displacement rotor (12) pass and aligns with another, each exchange their displacement weight (5) from the outer bounds of each to the inner bounds of the other resetting the displacement weights (5) to the inner bounds of each opposing and aligned displacement rotor (12) allowing displacement to repeat with the next synchronized rotation of the machine rotors (2). Each overlapping pair of displacement rotor (12) will continue to displace and reset with each new rotation of the two parallel, synchronized and overlapping machine rotors (2).

Claimed is:

1. A device for converting centrifugal force to energy comprising:
two or more machine rotors each with an axis of rotation each parallel, overlapping and synchronized with the other and further comprising:
a machine rotor each having an inner portion closest to the machine rotor axis of rotation and outer portion defined by the location and dimensions of the displacement mechanisms
a set of displacement mechanisms attached to the outer portion of each machine rotor aligned such that one end is closest to the machine rotational axis and the other end is farthest away from the machine rotor axis of rotation.
a displacement weight
an exchange capture/release mechanism located at each end of the displacement mechanism to capture and release the displacement weight
Wherein said machine rotors rotate on their respective axis of rotation generating power as each displace their respective displacement weights by way of their respective displacement mechanisms from the inner bounds of the machine rotor to the outer bounds of the machine rotor. As each displacement mechanism pass and aligns with another, each exchange their displacement weight from the outer bounds of each to the inner bounds of the other resetting the displacement weights to the inner bounds of each opposing and aligned displacement mechanism allowing displacement to repeat with the next synchronized rotation of the machine rotors. Each overlapping pair of displacement mechanisms will continue to displace and reset with each new rotation of the two parallel, overlapping, and synchronized machine rotors.

2. The device of claim 1 wherein said at least two machine rotors are coupled, parallel, overlapping and synchronized.

3. The device of claim 1 comprised of at least one displacement rotor attached to each machine rotor.

4. The device of claim 1 wherein power is generated with each displacement of each displacement weight.

5. The device of claim 4 wherein the power generated with each displacement of each displacement weight is transferrable to the shaft of the machine rotor increasing its rotational velocity or to any other device to which the power generated can be applied.

6. The device of claim 1 wherein a shaft is attached and runs parallel to the machine rotors axis of rotation and capable of rotating with said machine rotor.

7. The device of claim 6 wherein an electrical generator or other device converting power to work is coupled to said shaft.

8. A device for converting centrifugal force to energy comprising:
two or more machine rotors each with an axis of rotation each parallel, overlapping and synchronized with the other and further comprising:
a machine rotor each having an inner portion closest to the machine rotor rotational axis and outer portion defined by the location and dimensions of the displacement slide tracks
a set of displacement slide tracks attached to the outer portion of each machine rotor aligned such that one end is closest to the machine rotor axis of rotation and the other end is farthest away from the machine rotor axis of rotation
a displacement weight
an exchange capture/release mechanism is located at each end of the displacement slide track to capture the displacement weight at the end closest to the machine rotor axis of rotation allowing the displacement weight to move outward in response to centrifugal force to the end farthest away form the machine rotor axis of rotation and released to an opposing and aligned displacement slide track attached to an adjacent machine rotor.

9. The device of claim 8 wherein said at least two machine rotors are coupled, parallel, overlapping and synchronized.

10. The device of claim 8 comprised of at least one displacement rotor attached to each machine rotor.

11. The device of claim 8 wherein power is generated with each displacement of each displacement weight.

12. The device of claim 11 wherein the power generated with each displacement of each displacement weight is transferrable to the machine shaft increasing its rotational velocity or to any other device to which the power generated can be applied.

13. The device of claim 8 wherein a shaft is attached and runs parallel to the machine rotors axis of rotation and capable of rotating with said machine rotor.

14. The device of claim 13 wherein an electrical generator or other device converting power to work is coupled to said shaft.

15. A device for converting centrifugal force to energy comprising:
two or more machine rotors each with an axis of rotation each parallel, overlapping, and synchronized with the other and further comprising:
a machine rotor each having an inner portion closest to the machine rotor's axis of rotation and outer portion defined by the location and dimensions of the displacement rotor
a set of displacement rotors attached to the outer portion of each machine rotor having a displacement rotor pivot that bi-sects a lever to which one end a displacement weight is attached thereto causing an offset center of balance thereby allowing the displacement rotor to rotate on its displacement rotor pivot such that the segment of the lever closest to the machine rotational axis to which a displacement weight is attached rotates to the outer position farthest from machine rotational axis.
a displacement weight
an exchange capture/release mechanism located at each end of the displacement rotor to capture the displacement weight at that end of the lever closest to the machine rotor axis of rotation allowing the displacement weight to rotate in response to centrifugal force to a position farthest away form the machine rotor axis of rotation and released to an opposing and aligned displacement rotor attached to an adjacent parallel, overlapping and synchronized machine rotor.

16. The device of claim 15 wherein said at least two machine rotors are coupled, parallel, overlapping and synchronized.

17. The device of claim 15 comprised of at least one displacement rotor attached to each machine rotor.

18. The device of claim 15 wherein power is generated with each displacement of each displacement weight.

19. The device of claim 18 wherein the power generated with each displacement of each displacement weight is transferrable to the machine rotor drive shaft increasing its rotational velocity or to any other device to which the power generated can be applied.

20. The device of claim 15 wherein a drive shaft is attached and runs parallel to the machine rotors axis of rotation and capable of rotating with said machine rotor.

21. The device of claim 20 wherein an electrical generator or other device converting power to work is coupled to said drive shaft.
